(19) United States
(12) Patent Application Publication
(10) Pub. No.: US 2010/0118027 A1
(43) Pub. Date: May 13, 2010

(54) METHOD AND MEASURING ARRANGEMENT FOR PRODUCING THREE-DIMENSIONAL IMAGES OF MEASURING OBJECTS BY MEANS OF INVASIVE RADIATION

(75) Inventor: Daniel Weiss, Essingen-Forst (DE)

Correspondence Address: LERNER GREENBERG STEMER LLP, P O BOX 2480, HOLLYWOOD, FL, 33022-2480, US

(73) Assignee: CARL ZEISS INDUSTRIELLE MESSTECHNIK GMBH, Oberkochen (DE)

(21) Appl. No.: 12/594,652

(22) PCT Filed: Apr. 2, 2008
(86) PCT No.: PCT/EP08/02619

§ 371 Date: Oct. 5, 2009

(30) Foreign Application Priority Data
Apr. 3, 2007 (DE) 10 2007 016 370.5

(51) Int. Cl. G06T 15/00; G06K 9/00

(52) U.S. Cl. 345/419; 382/131

(57) ABSTRACT

Three-dimensional images of objects are produced from two-dimensional projection images. Invasive radiation is emitted from a radiation source, and a first set of projection images of the object is captured by a detection device. The projection images are captured at various directions of the object referenced to the radiation source and/or the detection device. A first three-dimensional image of the object is reconstructed from the first set of projection images, the first three-dimensional image is evaluated and depending on a result of the evaluation, a position and/or direction of the object in relation to the radiation source and/or in relation to the detection device is modified, and/or an operational mode of the measuring arrangement for obtaining subsequent projection images of the measuring object is adjusted. After the evaluation of the first three-dimensional image, a second set of projection images of the object is captured by the detection device.

The invention relates to a method and a measuring arrangement for generating three-dimensional images of test objects using invasive radiation. In particular, the three-dimensional images can be reconstructed by back-projection, taking into account a multiplicity of two-dimensional projection images of the test object. In particular, the invention can be applied in the field of examining workpieces, materials and/or industrially manufactured objects, e.g. for quality control in the series production of objects.

The use of invasive radiation for examining workpieces is known. In computed tomography (CT), the workpiece is for example generally arranged on a rotary table and is penetrated by X-ray radiation from various directions as a result of rotating the rotary table into various rotational positions. However, different geometries of the examination arrangement are also possible and known. A sensor device detects, in a spatially and temporally resolved fashion, radiation which is attenuated by absorption in the material of the workpiece. A three-dimensional (3D) image of the workpiece is calculated therefrom by applying one of a number of known methods of tomographic reconstruction, e.g. filtered back-projection. The 3D image respectively specifies the local linear absorption coefficient for individual small volume regions (voxels). An example of CT is described in DE 39 24 066 A1.

The 3D image can subsequently be used for e.g. qualitative or quantitative characterization of the test object. In the industrial application, this affords the possibility of for example non-destructive testing of all dimensions of a part, or qualitative tests e.g. for surface shrinkage.

The components of a micro-focus volume computed tomography system are in particular the micro-focus X-ray tube and a flat-panel detector for X-ray radiation. An X-ray source with a very small focal spot diameter (typically 5-100 μm) is implemented in the X-ray tube. The X-ray source generates polyenergetic X-ray radiation in the energy range of approximately ten to several hundred kilo-electronvolt. The radiation penetrates the object, is attenuated in the process (by absorption, but also in a different fashion, e.g. by scattering) and generates an X-ray image of the object on the detector device. The detector device usually has a scintillator which converts X-ray radiation into visible radiation and a photodiode array extending over a plane for the two-dimensional, spatially resolved measurement of the visible radiation. Further components of such a CT system include adjustment units for precise positioning and aligning of the test object, the X-ray source and/or the detector. The adjustment units provide signals by means of which the relative position of source, object and detector with respect to each other is known and/or determinable at all times with sufficient accuracy so as to ensure a precise reconstruction.

The projection images recorded using the flat-panel detector of a micro-focus CT measuring arrangement correspond to in particular central projections of the test object because the invasive radiation emanates in the form of a radiation cone from the approximately punctiform radiation source and penetrates the object as a bundle of divergent, straight rays. So as to be able to reconstruct the test object later, the test object is rotated in small angular steps about a rotational axis between the recording of the individual projection images and a projection is recorded for each rotational angle. Between 600 and 1200 projections are typically recorded per object, which projections cover the angular interval from 0 to 360 degrees in equidistant steps. It follows that the hardware (in particular X-ray source, rotary table, detector) utilized in a computed tomography scanner is used, in a first step, to generate a large number of central projections of the examination object at various projection directions. The subsequent step of object reconstruction is usually effected by software.

An algorithm developed inter alia by Feldkamp in 1984, which carries out a so-called back-projection, is usually used in the abovementioned cone beam geometry. The projections are firstly filtered by a high-pass filter and then back-projected, i.e. a pixel in a projection influences all voxels along the straight-lined line of sight which passes through the volume and belongs to the pixel. The value of each voxel emerges from the sum of all those pixel values in the (filtered) central projections which are impinged by the lines of sight passing through the voxel.

On the one hand, before each CT measurement, i.e. before the recording of the projection images starts, the test object should be positioned such that it fills as far as possible the dimensions (with respect to the radiation sensitive area of the detection device). This achieves a greatest possible magnification in the projection image and later in the reconstructed volume. On the other hand, in the generally used reconstruction method according to Feldkamp, the projection image of the object must not project beyond the detector in the horizontal direction or else artifacts are created in the reconstructed volume. Hence, in the case of small objects, the rotary table is generally positioned close to the radiation source so as to achieve a greatest possible magnification. However, due to the proximity of the radiation source, there is the risk of a collision between the test object and the radiation source when the test object is being differently aligned between individual projection records (e.g. by rotating the object on a rotary table). The radiation source and/or the object can be damaged in the collision. However, in any case the collision causes an unwanted displacement of the object relative to the positioning device (also referred to as adjustment units above), for example a displacement on the rotary table. This loses information about the relationship between the coordinate systems of the various projections. Processing the projection images for the purpose of reconstructing is then no longer possible.

The optimal arrangement of the object on the rotary table for every measurement is usually determined experimentally over a number of trials. To this end, the object is observed in the projection image from various rotation angles and the object is suitably displaced on the rotary table. Every such change in the position of the object on the rotary table for example comprises: switching-off the X-ray tube, opening the radiation protection door, displacing the object, closing the door and renewed switching-on of the tube. Overall, correct alignment of the object often requires more than five minutes. In light of the high investment costs for such equipment, this means significant additional costs as a result of the multiple manual alignment of the object.

Furthermore, it is the case in a conventional CT measurement that only once the measurement has been completed is it known which parts of the reconstructed volume actually contain object components, and which only contain air. It is for this reason that a (usually cylindrical) volume is generally reconstructed which contains the object but is often much larger than necessary. This leads to unnecessarily long calculation times during the reconstruction and unnecessarily large amounts of data which hinders the metrological evaluation (e.g. determining the dimensions of the test object).

It is an object of the present invention to specify a method and a measuring arrangement which enable an automatic and cost-effective determination of the shape, extent, position and/or alignment of the test object. In particular, it should be possible for the use of additional hardware (e.g. cameras) to be dispensed with.

The solution relates to in particular a method or a measuring arrangement which, using invasive radiation, generates projection images of test objects, for example in accordance with one of the refinements described above. In the process the invasive radiation penetrates (particularly in a straight line) the test object and is detected by a detection device of the measuring arrangement (which in particular undertakes measurements in a spatially resolved, two-dimensional fashion). Projection images of the test object are generated from the detection signals of the detection device, which signals correspond to the radiation detected by the detection device.

The measuring arrangement is preferably a computed tomography (CT) measuring arrangement, in particular a measuring arrangement with a measurement geometry which corresponds to a central projection emanating from a punctiform radiation source; for example with a micro-focus radiation source (in particular an X-ray tube) as a radiation source. Here, the term “corresponds” means that the projection image was in fact generated by a central projection or that the projection image was generated by a measuring arrangement which generates irradiation images (projection images) which are identical to a central projection (e.g. by deflecting the invasive radiation before and/or after irradiating the object, e.g. by collimators and/or lenses). A central projection is understood to mean that the path of each beam of the invasive radiation from the punctiform radiation source to the detection device is a straight line. A radiation source is also referred to as punctiform if the generation region of the radiation or a region through which all radiation used in the projection has to pass through is so small in the context of the overall geometry of the measuring arrangement that the region can be considered to be approximately punctiform.

A positioning device for positioning and/or aligning the test object relative to the radiation source and/or relative to the detection device is preferably also available, with the positioning and/or alignment being effected mechanically (preferably automatically).

Furthermore, the measuring arrangement has a reconstruction device for generating (reconstructing) a three-dimensional image (volume image) of the respective test object from a plurality of the projection images.

By way of example, a combination of a scintillator material and a field of photodiodes is suitable for the detection device. The radiation and/or particles are incident on the scintillator material and are converted there into visible radiation which is detected by the photodiodes. However, other detection devices can be used as well.

The term “invasive radiation” comprises any type of radiation which passes through the test object. In addition to electromagnetic radiation such as X-ray radiation, particle radiation (e.g. electron, neutron, positron radiation) can also be used. The use of electromagnetic radiation in other wavelength bands (e.g. in the visible or infrared wavelength band) is also possible if the test object is correspondingly permeable.

Furthermore, the electromagnetic radiation is preferably X-ray radiation or gamma radiation (hard X-ray radiation) in the energy range from 0.5 keV to 50 MeV. X-ray radiation in the energy range from 2 keV to 700 keV is particularly preferred.

When using X-ray radiation sources with a small focal spot, the source of the invasive radiation can be assumed to be almost punctiform. Such a measuring arrangement with an almost punctiform radiation source is likewise particularly preferred. By way of example, an X-ray radiation source with a focal spot diameter in the range from 5 to 100 micrometers is used. Sources of this type generally generate polychromatic X-ray radiation, e.g. in the energy range from 10 to 450 keV. In view of the generally significantly larger distance to the test object and to the detection device (of the order of tens of centimeters to over a meter) compared to the focal spot diameter, the focal spot can be referred to as punctiform.

The images recorded by the detection device (or the corresponding image data) comprise information relating to the intensity of the invasive radiation which has passed through the test object. From this information, the so-called cumulative absorption coefficient can be calculated for each pixel of the image in a known fashion.

In accordance with a main idea of the present invention, a first set of projection images of the test object is recorded, wherein the projection images are recorded at various alignments of the test object relative to the radiation source and/or relative to the detection device. Thus, as a result, a set of first projection images is available which correspond to projections from various directions. A first three-dimensional image of the test object is subsequently reconstructed from this first set. This first three-dimensional image can now be evaluated so as to prepare the recording of a second set of projection images of the test object.

Before the first set is recorded, the test object does not have to be positioned and/or aligned in an optimal fashion relative to the radiation source and relative to the detection device. Rather, the test object can be arranged such that the radiation which passes through the test object only impinges on a small part of the area of the detection device available for the detection. Hence the test object is not arranged such that it fills the area. However, this completely suffices for reconstructing a first three-dimensional image of the test object. However, before the first set of projection images is recorded, the test object is preferably arranged such that any invasive radiation of the radiation source which passes through the test object in a straight line is detected by the detection device. This affords the possibility of detecting all contours of the test object.

Evaluating the first three-dimensional image permits preparing the actual recording of projection images in a number of ways, with it being possible for the method steps for preparing the actual measurement, which are explained in more detail in this description, to be carried out individually or in any combination with one another. In particular, the contours of the test object in the first three-dimensional image can be used to determine the exact position and alignment of the test object relative to the measuring arrangement and/or relative to one or more parts of the measuring arrangement. Hence it is possible for the position and/or alignment to be varied before the recording of a second set of projection images, with the variation being based on the findings of the evaluation of the first 3D image of the test object.

When reference is made here to the first three-dimensional image, this also includes the case in which more than one set of projection images are recorded and a reconstructed 3D image of the test object is generated for each set. This plurality of first sets can then be evaluated so as to prepare the actual measurement of the test object by recording a further (second) set of projection images.

Other than correcting the position and/or alignment of the test object, the method of operation of the measuring arrangement during the recording of further projection images can also be prepared. Thus, by way of example, it is possible not to change the position and/or alignment of the test object before recording a second set of projection images, but rather in each case to change the position and/or alignment of the test object between the recordings of the individual projection images of the second set. By way of example, if, when a rotary table is used, the optimum alignment of the test object with respect to the rotational axis of the rotary table is not achieved, then the rotary table with the test object arranged thereon can be displaced about its rotational axis during each rotation (which respectively occurs between recording two subsequent projection images) such that as a result a rotation about the optimum rotational axis of the test object is achieved between the recordings. In particular, the optimum rotational axis of the test object is an axis which is traversed perpendicularly by the central beam of a beam cone of the invasive radiation, with this beam impinging on the center of the radiation sensitive detection surface of the detection device.

Furthermore, the recording of the second set of projection images can be prepared in that, during the recording of the second set, only those detection signals of the detection device are recorded which lie within a defined partial region of the detection surface sensitive to radiation. Here, this partial region for recording the second set can be constant or can vary between recordings of a projection image. By way of example, a voxel of the three-dimensional coordinate system in which image information relating to the test object is to be expected is identified from the first 3D image of the test object. In particular, a cover surface can be determined from the first 3D image which covers all 3D pixels of the reconstructed test object. Such a cover surface is for example a cuboid with external surfaces aligned with the coordinate axes of the 3D coordinate system in which the first 3D image is defined. Alternatively, the cover surface can for example be a cylinder surface, the axis of rotational symmetry thereof running parallel to the z-axis of the measuring arrangement, with the z-axis being an axis running parallel to the rotational axis of a rotary table of the measuring arrangement, on which rotary table the test object is arranged. In particular, the axis of rotational symmetry of the cylinder surface can coincide with the rotational axis of the rotary table.

If the position and alignment of the test object are no longer varied between the recording of the first set and the recording of the second set of projection images, the cover surface determined from the first 3D image defines the region in which information relating to the test object can be expected. All other regions of the 3D coordinate system do not have to be taken into account when reconstructing a second 3D image from the second set of projection images. This affords the possibility of reducing the computational time during the reconstruction and saving storage space for storing (both recorded and reconstructed) image data.

The invention in particular relates to a method for generating three-dimensional images of test objects using invasive radiation, in particular by means of back-projection taking into account a multiplicity of two-dimensional projection images, wherein
a test object is penetrated by invasive radiation on a measuring station of a measuring arrangement, in which the invasive radiation emanates from a radiation source of the measuring arrangement,
a first set of projection images of the test object is recorded by a detection device of the measuring arrangement, in which the projection images are recorded at various alignments of the test object relative to the radiation source and/or relative to the detection device,
a first three-dimensional image of the test object is reconstructed from the first set of projection images,
the first three-dimensional image is evaluated and possibly, depending on a result of the evaluation, a position and/or an alignment of the test object is varied relative to the radiation source and/or relative to the detection device and/or, depending on a result of the evaluation, a method of operation of the measuring arrangement is adjusted for a subsequent recording of projection images of the test object,
a second set of projection images of the test object is recorded by the detection device of the measuring arrangement after the evaluation of the first three-dimensional image.

It is preferable for the complexity of recording, processing and/or reconstructing the first set of projection images to be reduced in comparison with the complexity of recording, processing and/or reconstructing a second set of projection data.

In particular, it is possible for the projection images of the first set of projection images to have a first image resolution in the reconstruction of the first three-dimensional image which is lower than an image resolution of the projection images of the second set of projection images. In particular, the number of pixels per image is reduced. By way of example, in the first set of projection images, only 256×256 pixels are stored and processed per projection image, whereas each of the second projection images has 1024×1024 pixels. Therefore, processing and reconstruction of the first projection images is significantly faster and requires fewer resources.

Furthermore, the first set of projection images can have a smaller number of projection images than the second set. In practice it was found that e.g. 10 to 20 projection images with respectively varying projection direction (e.g. at 10 to 20 different rotational positions of the rotary table) suffice so as to obtain a first reconstructed 3D image of the test object, which contains all information required for preparing the recording of the second set. By contrast, as mentioned, the set of projection images during the actual measurement of the test object typically has 600 to 1200 projection images.

Therefore, (formulated more generally,) it is proposed that the projection images of the second set are recorded at more various alignments of the test object relative to the radiation source and/or relative to the detection device than the projection images of the first set of projection images.

In accordance with a further method for reducing the complexity, projection images of the first set of projection images for reconstructing the first three-dimensional image are generated as digital images, the pixels of which having a binary image value. Binary means that the pixels can only have one of two possible image values, e.g. “0” or “1”. By way of example, although the usual grayscale image is firstly generated from the detection signals of the detection device, in which image each pixel is assigned one of many possible grayscale values, a decision is subsequently made for each pixel as to whether the first or the second binary image value is assigned to said pixel. In particular, the binary image values can be generated by determining for each pixel whether an image value obtained by the detection device is either above a threshold or is less than or equal to the threshold. In the first case the pixel obtains the first image value, in the second case the second image value. Alternatively it can be determined whether the image value obtained by the detection device is greater than or equal to the threshold (first case) or whether it lies below the threshold (second case).

A projection of the three-dimensional image onto a projection plane can be calculated so as to evaluate the first three-dimensional image. A decision can then be made on the basis of a projection result as to whether and possibly how a position and/or alignment of the test object is varied relative to the radiation source and/or relative to the detection device and/or whether and possibly how a method of operation of the measuring arrangement is adjusted for a subsequent recording of projection images of the test object. When using a rotary table in the measuring arrangement, the projection plane is preferably perpendicular to the rotational axis of the rotary table.

The result of this projection of the reconstructed image can be referred to as the “footprint” of the test object. The footprint or the projection result can easily show in an evaluatable fashion where information relating to the test object is to be expected. Furthermore, the projection result makes it possible to determine whether and possibly how the position and/or alignment of the test object have to be varied relative to the measuring arrangement or relative to parts of the measuring arrangement (e.g. relative to the rotary table) so as to be able to record an optimal set of second projection images.

By way of example, so as to evaluate the projected image, this image can be fitted into a contour line of a predetermined shape. The predetermined shape is for example a circular line (but with a variable radius) and/or a rectangular line (with variable edge lengths of the rectangle). The radius or edge lengths and also the position of the contour line are determined by fitting the projected image into the contour line. In particular, fitting in is understood to mean that the contour line is dimensioned and arranged in the coordinate system of the projected image such that it comprises all pixels of the test object in the projected image. Here, although the pixels of the test object in the projected image can touch the contour line, they cannot be projected beyond the latter. In particular, the circular line with the smallest possible radius or the rectangle with the smallest possible edge lengths is determined.

Moreover, the scope of the invention includes a computer program with program code means designed to execute the method steps of the method according to the invention when the computer program is executed on a computer or computer network; in particular the following procedures:
a first set of projection images of the test object which were recorded by a detection device of the measuring arrangement is loaded and/or received for data processing, in which the projection images were recorded at various alignments of the test object relative to the radiation source and/or relative to the detection device,
a first three-dimensional image of the test object is reconstructed from the first set of projection images,
the first three-dimensional image is evaluated and possibly, depending on a result of the evaluation, control signals are generated which effect a variation in position and/or alignment of the test object relative to the radiation source and/or relative to the detection device when the control signals are effected, and/or, depending on a result of the evaluation, control signals are generated which, when effected, adjust a method of operation of the measuring arrangement for a subsequent recording of projection images of the test object.

Further possible method steps executed by the computer program have already been mentioned (e.g. the evaluation and/or the reconstruction of the first set of projection images). Measures which are taken due to the evaluation for preparing the recording of the second set of projection images can also be executed by the program code means of the computer program. In particular, this includes the calculation of how the position and/or alignment of the test object should be varied before recording the second projection images or how the method of operation of the measuring arrangement should be adjusted for recording the second projection images.

Furthermore, the scope of the present invention includes a measuring arrangement for generating three-dimensional images of test objects using invasive radiation. Features of the measuring arrangement have already been mentioned and in particular emerge from the description of the method according to the invention. In particular, the measuring arrangement comprises the following:
a measuring station at which, during the operation of the measuring arrangement, a test object is penetrated by invasive radiation emanating from a radiation source,
a detection device for recording projection images of the test object, which are a result of the invasive radiation being absorbed in the test object,
a reconstruction device designed to reconstruct a first three-dimensional image of the test object from a first set of projection images of the test object, wherein the projection images were recorded at various alignments of the test object relative to the radiation source and/or relative to the detection device,
an evaluation device designed to evaluate the first three-dimensional image and
a control device designed, possibly, depending on a result of the evaluation device, to vary a position and/or an alignment of the test object relative to the radiation source and/or relative to the detection device and/or, depending on a result of the evaluation, to adjust a method of operation of the measuring arrangement for a subsequent recording of projection images of the test object.

The measuring arrangement usually also includes the radiation source of the invasive radiation. However, it is for example also possible that only a support for such a radiation source is part of the measuring arrangement and so the radiation source can be interchanged.

Features of the previously mentioned devices, in particular of the reconstruction device, the evaluation device and the control device, emerge from the description of the method according to the invention and from the appended patent claims.

The invention will now be explained in more detail on the basis of exemplary embodiments. The exemplary embodiments also include the best exemplary embodiment according to current knowledge. In the description, reference is made to the attached drawing. However, the invention is not restricted to the exemplary embodiments. Individual features or any combination of features of the exemplary embodiments described in the following text can be combined with the above-described refinements of the invention. In the individual figures of the drawing,

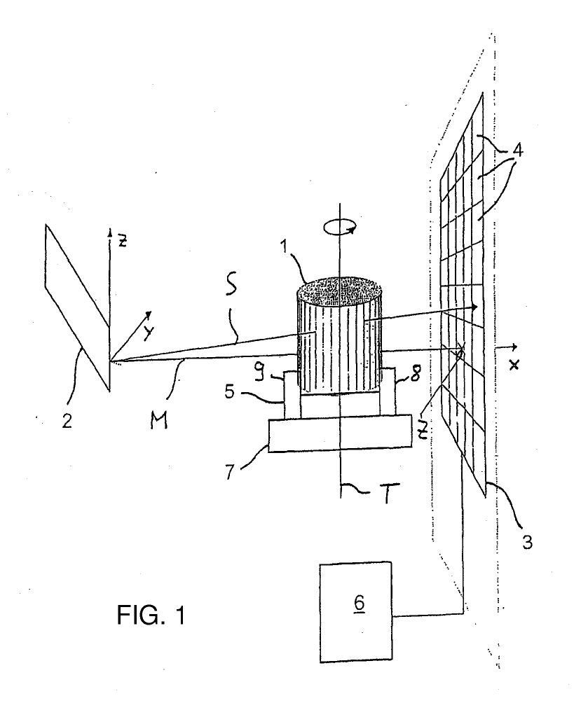

FIG. 1 shows a measuring arrangement geometry with an X-ray radiation source, a test object and a two-dimensionally spatially resolving detector device,

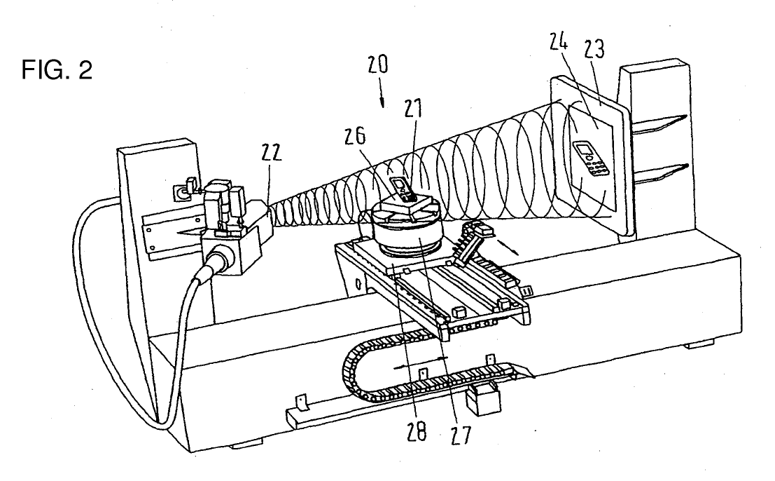

FIG. 2 shows a second measuring arrangement with test object arranged on a rotary table,

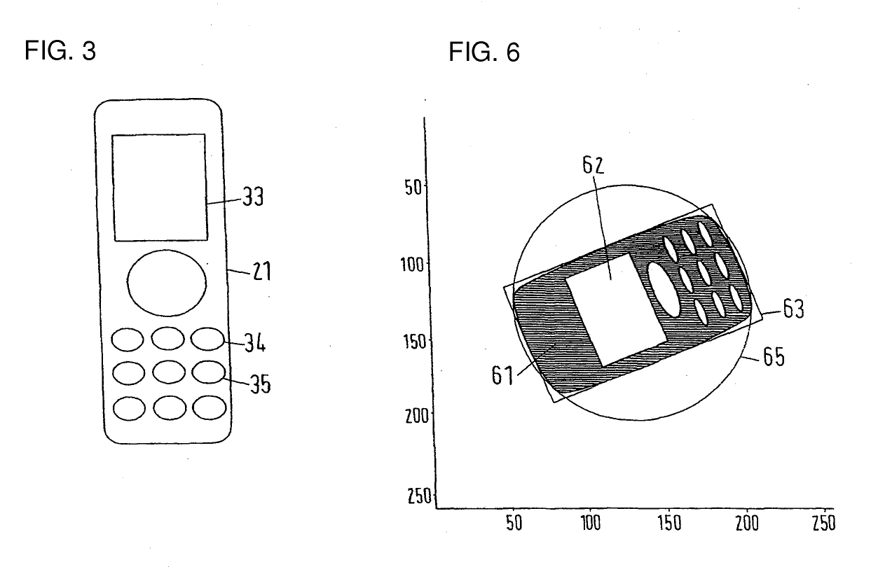

FIG. 3 shows a view of the test object in accordance with FIG. 2,

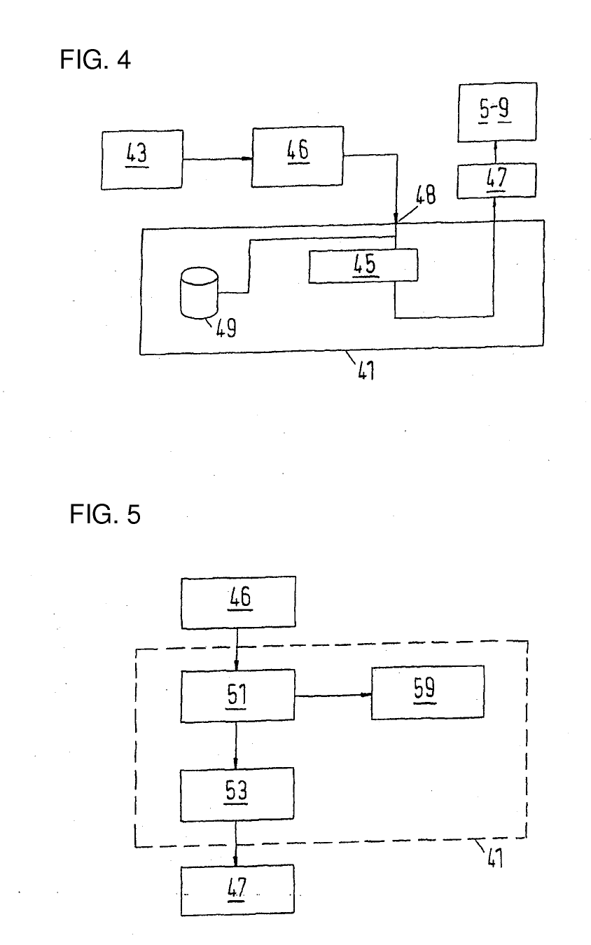

FIG. 4 shows a schematic illustration of components of an arrangement for detecting and evaluating detection signals,

FIG. 5 shows details of parts of the arrangement illustrated in FIG. 4 and

FIG. 6 shows a footprint of a test object.

The measuring arrangement illustrated in FIG. 1 has a test object 1 which is arranged in the straight-line beam path between a radiation source 2, in particular an X-ray radiation source, and a detection device 3. The detection device 3 has a multiplicity of detection elements 4 such that a spatially resolved detection of radiation is possible. The detection signals from the detection elements 4 are fed to a device 6 which determines in each case an irradiation image of the test object 1 in a given rotational position of the test object 1. The test object 1 is combined with a rotational device 7, e.g. a rotary table. The rotational axis of the rotational device 7 is labeled by T. Moreover, a positioning device 5 is provided which affords the possibility of positioning the test object 1 relative to the rotational device.

The positioning device 5 is preferably designed such that it separately permits the positioning of the test object 1 in the direction of three coordinate axes x, y, z of a Cartesian coordinate system. Thus, erroneous positioning of the test object 1 can be corrected by linear motion, respectively in the direction of the individual coordinate axes. Alternatively, or additionally, the positioning device 5 can permit further positioning motions, e.g. rotational motions about a rotational axis which does not coincide with the rotational axis T of the rotational device 7. This also affords the possibility of for example correcting tilts of the test object relative to a rotary table surface. All of these positioning measures can be effected as a function of an evaluation of a previously recorded reconstructed image of the test object 1.

In particular, the positioning device 5, as is illustrated schematically in the exemplary embodiment according to FIG. 1, is arranged between a surface of the rotational device 7 (e.g. the surface of the rotary table) and an underside of the test object 1. However, other arrangements are also feasible. By way of example, the test object can be gripped by an element of the positioning device and laterally extend away from the positioning device. As indicated in FIG. 1 by two lateral clamping jaws 8, 9 of the positioning device 5, the test object 1 can be clamped in the positioning device 5. However, it is also possible that the test object is arranged on the positioning device in another fashion. By way of example, the test object can be placed merely onto a footprint of the positioning device or the rotary table, or can (preferably) be held by an additional body made of a material (e.g. polystyrene) which lets the invasive radiation pass almost without any absorption.

A Cartesian coordinate system of the measuring arrangement is illustrated in FIG. 1. The x-axis extends from the radiation source 2 (e.g. the focal spot of the radiation source), which is punctiform to a good approximation, to the detection device 3 through the measuring station on which the test object can be arranged. A beam M of the invasive radiation generated by the radiation source 2 and running precisely along the x-axis pierces the detection device 3 at a puncture point Z or impinges an appropriate detection element, and is detected there.

The detection device 3 is preferably a device with a planar detection surface impinged by the radiation to be detected, with the planar detection surface being perpendicular to the x-axis. The rotational axis T of the rotational device 7 should usually be adjusted such that it runs perpendicularly to the x-axis and, moreover, such that the x-axis is the central axis of a radiation cone generated by the radiation source 2. A further beam of the radiation cone in FIG. 1 is referred to by the reference symbol S.

The y-axis of the coordinate system of the measuring arrangement extends parallel to the detection plane of the detection device 3, specifically in the horizontal direction. The z-axis of the coordinate system also extends parallel to the detection plane and, moreover, preferably parallel to the rotational axis T.

The measuring arrangement 20 illustrated in FIG. 2 has a radiation source 22 which emits radiation within a radiation cone. The radiation cone, with the radiation source 22 lying at the tip thereof, expands with increasing distance from the radiation source 22 because the radiation is a divergent radiation bundle. This radiation bundle passes through the test object 21 in places and impinges on the detection surface 24 of a detection device 23 sensitive to the invasive radiation.

The test object 21 is for example the outer shell of a mobile phone. The test object 21 is held by a block 26 of material through which the invasive radiation can pass with almost no absorption. The block 26 is arranged on a rotary table 27, the rotational axis of which runs in the vertical direction in the illustration of FIG. 2. The rotary table 27 in turn is arranged on a linearly moveable table 28 of a positioning device. The table 28 can be displaced in a direction which runs horizontally and in the process runs parallel to the planar detection surface 24 of the detection device 23.

The table 28 in turn is displaceable both in the vertical direction, i.e. likewise parallel to the detection surface 24, and in a direction which runs parallel to the normal of the detection surface 24.

It can be seen from FIG. 2 that the test object 21 is arranged such that its longitudinal axis does not coincide with the rotational axis of the rotary table 27 or does not run parallel to the rotational axis. The longitudinal axis can be skew with respect to the rotational axis, or cut the latter. This makes it possible for artifacts to be avoided during the reconstruction of the test object from the projection images when the projection images are recorded at various rotational positions of the rotary table 27.

FIG. 3 shows the test object 21 illustrated in FIG. 2 in a magnified illustration. It can be seen that the test object has cutouts 33, 34, 35.

The arrangement illustrated in FIG. 4 is for example part of the arrangement in accordance with FIG. 1 or part of the arrangement in accordance with FIG. 2. The detection device 43 for detecting the invasive radiation attenuated by the test object is connected to a device 46 which converts the analog signals of the detection device 43 into digital signals and integrates the signal over time for each detection element (e.g. the elements 4 in accordance with FIG. 1). Therefore, all information required for an individual projection image of the test object is available at the output of the device 46.

Each of these projection images recorded at various rotational positions of the test object is received by a computer 41 via an input 48 thereof and stored in data storage 49 of the computer. Moreover, the projection images received by the input 48 are either directly transferred to a processor 45 of the computer 41 or are read out by said processor from the data storage 49. The processor 45 is software-controlled and is able to calculate a reconstruction of the test object from the respectively available set of projection images. Therefore a reconstruction device 51 connected to the device 46 is implemented in the computer 41 (as illustrated in FIG. 5).

Furthermore, the processor 45, likewise controlled by software, is able to evaluate the reconstructed image. Depending on whether the reconstructed image is the first three-dimensional image for preparing the actual measurement of the test object or whether it is the reconstructed image generated from the actual measured data, the processor 45 either executes an evaluation for preparing the actual measurement (illustrated by the evaluation unit 53 in FIG. 5) or executes an evaluation of the actual measured data (illustrated in FIG. 5 by device 59), e.g. a comparison of the dimensions of the test object and reference dimensions.

So as to prepare the actual measurement of the test object, the processor 45 or the evaluation device 53 is connected to a control device 47 which (as illustrated in FIG. 4) actuates for example elements 5 to 9 (see the description relating to FIG. 1) of a positioning device for positioning the test object relative to the measuring arrangement.

The following text describes a particularly preferred refinement of the method according to the invention. In the process, reference is in turn made in places to the attached figures.

The method described in the following text permits, in a quick and automated fashion, the preparation of the measurement of a test object. First of all, using for example the arrangement illustrated in FIG. 1 or FIG. 2 (in the following text, only the reference symbols in accordance with FIG. 2 are used for the sake of simplicity), a first set of ten to twenty X-ray images of the test object 21 is recorded in various rotational positions relative to the measuring arrangement. Since this first set is recorded using the same measuring arrangement 20, in particular the same detection device 23, as the actual set of projection images to be recorded later, additional aids for aligning the test object 21 (e.g. a camera which simulates the X-ray optical beam path) are not required.

The detection device 23 records X-ray images of the test object 21 in various rotational positions. In the process, the test object can be in arbitrary positions and alignments on the rotary table 27. In the case of a usual exposure time of 0.5-1 second, the recording of the projection images takes at most 30 seconds. The 10-20 images for example cover the whole angular range of 360° of the rotary table 27.

Subsequently a reconstructed three-dimensional image of the test object 21 is calculated using e.g. filtered back-projection. The three-dimensional image is specified in the coordinates of the measuring arrangement 21. It has a value for each individual volume region (voxel) of the image, which value is a measure of the attenuation of the X-ray radiation in the voxel.

The projection images for preparing the actual measurement of the test object 21 are not processed with the digital resolution available to the actual measurement. In the case of a flat-panel detector with 1024×1024 pixels, e.g. the projection images are reduced to a resolution of 256×256 pixels (e.g. controlled by the processor 45 by means of software), wherein it follows that in each case 16 pixels are reduced to one pixel. The back-projection is therefore only effected for a volume of 256³ pixels.

In the next step, each projection image is separated into object and background by calculating the quotient of object image and empty image per pixel and then by binarizing the pixel value by using a suitable threshold, that is to say by setting the pixel value to either “1” (object) or “0” (background). The empty image was recorded in advance by a recording without a test object, wherein the detection signals of the detection device were e.g. integrated over the same time as was used during the recording of the first projection images. Inhomogeneous illumination and sensitivity of the detection device are taken into account by using the empty image. Since the detection signals are subject to noise (caused by the detection electronics and by photon noise), the threshold for binarization should not be selected to be too high because otherwise background signals could erroneously be classified as object signals. By contrast, if a threshold is too low there is the risk of erroneously classifying image signals from very thin object parts as background signals. A threshold of 97% of the empty image intensity was proven in practice.

Since it is only a space with a reduced number of voxels (e.g. with a size of 256³, cf. above) which results from the reconstruction and because only binary image values are used, a data storage space of e.g. 16 MB suffices. It is for this reason that the binary reconstruction can be effected on an individual commercially available personal computer and, unlike the reconstruction of the actual measured data, does not have to be carried out distributed over a number of computers or by a supercomputer. All binary projection images are back-projected into the 3D space on the basis of the current projection geometry. In the process the object is “cut out” of the original volume block by the background regions (including hollow spaces in the test object) in each projection being used to set all voxels associated therewith to 0. Formulated more generally, a voxel in the space available for reconstructing the test object is marked as no longer being required in that associated two-dimensional image regions of the projection images are allocated that binary value which corresponds to a not-present attenuation of the invasive radiation and in that these two-dimensional image regions are transferred to the voxel.

Since only 10-20 projection images are used for the first set and a reduced work volume (e.g. 256³) is used in the example, this back-projection step only requires a few seconds. In total, all method steps (recording the image and evaluation) can be effected in significantly under one minute, that is to say during a period of time which is very much shorter than the manual positioning of the test object in the measuring arrangement.

Due to the simplification of the image and the use of only a few projections, the binary volume shows a rough approximation of the object which is not suitable for the actual measurement. However, it suffices for preparing the actual measurement.

A preferred form of the further evaluation of the binary volume consists of a maximum projection in the x-y plane (see FIG. 1), i.e. in a plane which runs perpendicularly to the axis of rotation of the rotary table 7 or 27. In the process, a check is made for each z-column (column of voxels, the x and y values of which are equal) of the binary volume as to whether object parts are contained in said column. If this is the case, the column is characterized by the value “1” in the binary volume, or the value “1” for “attenuation by the object” is inserted in a corresponding two-dimensional projection image. Using this, a “footprint” of the object in the overall accessible reconstruction volume is obtained. It is for this reason that the maximum projection can also be referred to as a binary projection onto an image plane of the image volume obtained from the reconstruction. This image plane is preferably in the plane (or parallel thereto) of the footprint of the rotary table onto which the test object or a holder for the test object can be placed.

Using image processing methods known from the field of digital image processing, at least one external contour (contour line) is preferably determined automatically from the maximum projection. This contour defines the region in the reconstruction volume or in the image projected therefrom which contains the test object.

In the following text, reference is made to FIG. 6 which illustrates the footprint 61 in a two-dimensional image plane of 256×256 pixels (x-y plane or parallel thereto). A region 62 can also be seen within the footprint 61 which corresponds to a cutout in the test object 21.

A rectangular line is a first contour line 63. The likewise automatically determinable smallest circumscribing circle is a second contour line 65.

There is no binary image value signifying the presence of absorbing material outside of the two contour lines 63, 65. Here, the contour lines 63, 65 are placed around the footprint 61 such that on opposite edges of the contour lines 63, 65 in each case a few of the binary pixels of the object lie on the contour line 63, 65.

The circular contour line 65 (the smallest circular line circumscribing the test object) shows how this test object has to be aligned for maximum magnification. By way of example, this can be used to calculate the displacement of the test object 21 on the rotary table 27 required to arrange said test object 21 in the center of the rotary table 27 in the case of maximum magnification. All that has to be determined is how far and in what direction the center of the circular line has to be displaced so as to coincide with the puncture point of the rotational axis. Furthermore, the reciprocal value can be determined from the ratio of the diameter of the circular line (in pixels) to the size of the two-dimensional image in accordance with FIG. 6 (likewise in pixels). This reciprocal value specifies the factor by which the image of the test object can still be magnified, e.g. by the rotary table correspondingly approaching the radiation source.

The rectangular contour line 63 (possibly magnified by the magnification factor defined in the preceding paragraph) specifies that the region located outside of the rectangle does not have to be reconstructed since no regions of the test object are expected to be there. By determining this rectangle, the reconstruction time and the size of the reconstruction file can be minimized.

As a result of the binarization using the threshold, it is possible for part of the test object to be outside of one of the contour lines if this part only very weakly absorbs the invasive radiation. This can either be accepted if they are parts which are of no interest, e.g. sticky tape for fixing the test object, or the region to be evaluated can be selected to be slightly larger than what is defined by the contour line. A further possibility consists of selecting a higher threshold such that background pixels may also be marked as an “object” and then effecting a check for image regions connected to one another. If there are regions marked as an “object” which are small and are not connected to relatively large regions, the small regions can be marked as “not object” (or “background”), i.e. the pixel value “0” can be written.

The circumscribing rectangular line 63 contains (to a good approximation) the entire object. Due to the projection, this holds for all planes parallel to the projection plane, i.e. for all “slices” of the volume. The rectangle comprises e.g. 600×395 voxels, i.e. only 22.6% of all voxels in the 1024×1024 pixel layer in a regular, non-reduced resolution. Thus, in this example, less than a quarter of all voxels have to be reconstructed and stored. Since the method according to the invention generates this information before the start of the actual measurement, this information can be taken into account during the actual measurement of the test object and the reconstruction of the actual measured data.

Furthermore a rotational angle can be determined from the circumscribing rectangle 63 through which the rectangle 63 can be rotated such that the edge lines of the rectangle 63 are parallel to the coordinate axes of the x-y plane (22.6° in this example). This rotational angle can be accounted for during the reconstruction of the actual measured data (see preceding paragraph). This optimization of the reconstruction time and the size of the reconstruction file has no negative influence on the accuracy of the measurement result, i.e. the measurement result is not negatively affected by the rotation about the mentioned rotational angle. This is because the rotation is not an additional processing step after the reconstruction, but rather it can be set e.g. by a parameter of the reconstruction and therefore implies no additional computational complexity. In the back-projection, each projection image is back-projected in the volume at the angle at which it was recorded. If a constant value is added to each angle then this effects the rotation of the reconstructed test object in the volume by precisely this value. This affords the possibility of within the volume assigning an arbitrary rotation about the z-axis to the reconstructed object, e.g. into a position which aligns the reconstructed test object parallel to the volume axes and thus minimizes the spatial requirements.

The rotational angle can also already be taken into account for the recording of the actual projection images, for example, by starting with recording a projection image in a rotational position of the rotary table 27, which position is rotated by said rotational angle compared to the rotational position corresponding to FIG. 6.

What was described up until now was determining the extent of the object in the x- and y-directions. The binary volume can also be used in a simple manner to determine a lower and upper boundary in the z-direction (i.e. perpendicular to the projection plane in accordance with FIG. 6, e.g. in the direction of the rotational axis) such that the reconstruction volume can be optimally matched to the actual size of the examination object in all three dimensions.

Instead of an individual rectangular or cuboid outline which surrounds the object as tightly as possible, it is also possible to determine a number of outlines in the binary volume which together surround the object. In the case of a suitable object shape, this affords the possibility of fitting the reconstruction volume to the actual object shape in an even more improved fashion, i.e. said volume can be reduced further. Differently shaped contour lines and contour surfaces can also be used, e.g. polygonal contour lines. This is particularly advantageous in the case of tomography scanners with a 2048×2048 detector, where very long reconstruction times could otherwise occur.

In addition or as an alternative to the above-described method during the evaluation, the method can be used to avoid a collision between the object and the X-ray tube in the case of small objects and a large magnification. By way of example, to this end the circular line illustrated in FIG. 6 is used as a line of the maximum object extent due to a rotation of the rotary table 27. If the geometry of the X-ray tube with respect to the X-ray source is known (on the basis of the CAD drawing of the tube), the object can automatically approach the tube to the smallest possible distance without a collision being a possible outcome.

Between recording respectively two projection images, it is also possible for the test object to be displaced in the x-y plane (i.e. perpendicular to the rotational axis of the rotation) during the rotation of said object. This can implement an effective rotation about every location on a rotary table and not only about the location of the actual rotational axis. A suitable location for the effective rotational axis can be determined with the method presented above (e.g. the center of the circular line 65). This affords the possibility of positioning a test object at any location on a rotary table and nevertheless obtaining an optimum reconstruction without having manually to move the object on the rotary plate.

1-20. (canceled)

21: A method for generating three-dimensional images of test objects using invasive radiation, the method which comprises:
providing a measuring configuration with a radiation source emanating invasive radiation that penetrates a test object on a measuring station of the measuring configuration;
using a detection device of the measuring configuration to detect a first set of projection images of the test object, wherein the first set of projection images is detected at various alignments of the test object relative to the radiation source and/or relative to the detection device;
reconstructing a first three-dimensional image of the test object from the first set of projection images;
performing an evaluation of the first three-dimensional image and, depending on a result of the evaluation, performing at least one step selected from the group consisting of:
varying at least one of a position and an alignment of the test object relative to at least one of the radiation source and the detection device, and
adjusting a method of operation of the measuring configuration for subsequently recording a second set of projection images of the test object; and
using the detection device to detect the second set of projection images of the test object after performing the evaluation of the first three-dimensional image.

22: The method according to claim 21, which further comprises performing the step of reconstructing the first three-dimensional image such that the first three-dimensional image has a first image resolution that is lower than an image resolution of three-dimensional images that are reconstructed from the second set of projection images.

23: The method according to claim 21, which further comprises generating the first set of projection images as digital images with pixels having binary image values.

24: The method according to claim 23, which further comprises generating the binary image values by, for each of the pixels, comparing an image value obtained by the detection device with a threshold value.

25: The method according to claim 21, which further comprises when performing the step of using the detection device to detect the second set of projection images, detecting the second set of projection images using a number of different alignments of the test object relative to the radiation source and/or relative to the detection device that is greater than a number of different alignments of the test object relative to the radiation source and/or relative to the detection device that were used to obtain projection images of the first set of projection images.

26: The method according to claim 21, which further comprises when performing the evaluation of the first three-dimensional image:
calculating a projection of the three-dimensional image onto a projection plane; and
based on the projection, making at least one determination selected from a group consisting of:
determining whether at least one of a position and an alignment of the test object should be changed relative to at least one of the radiation source and the detection device,
determining whether a method of operating the measuring configuration should be adjusted for subsequently detecting projection images of the test object; and
determining how the method of operating the measuring configuration should be adjusted for subsequently detecting projection images of the test object.

27: The method according to claim 26, which further comprises: when performing the step of calculating the projection of the three-dimensional image onto a projection plane, the projection plane is perpendicular to a rotational axis of a rotary table being used to rotate the test object relative to the radiation source.

28: The method according to claim 26, which further comprises fitting the projection of the three-dimensional image into a contour line of a predetermined shape such that although the projection of the three-dimensional image touches the contour line, the projection of the three-dimensional image does not project beyond the contour line.

29: The method according to claim 21, which further comprises performing the step of reconstructing the first three-dimensional image of the test object from the first set of projection images by using a back-projection procedure.

30: A computer-readable medium having a set of computer or computer network executable instructions stored thereon for causing the computer or the computer network to perform the following method:
loading and/or receiving a first set of projection images of the test object, wherein the first set of projection images was obtained using a detection device of a measuring configuration, and wherein the first set of projection images was recorded at various alignments of the test object relative to the radiation source and/or relative to the detection device;
reconstructing a first three-dimensional image of the test object from the first set of projection images;
performing an evaluation of the first three-dimensional image and, depending on a result of the evaluation, generating control signals for performing at least one step selected from the group consisting of:
varying at least one of a position and an alignment of the test object relative to at least one of the radiation source and the detection device, and
adjusting a method of operation of the measuring configuration for subsequently recording projection images of the test object.

31: The computer-readable medium according to claim 30, wherein:
the executable instructions are designed to evaluate a second set of projection images of the test object after the first three-dimensional image has been evaluated; and
the second set of projection images was recorded by the detection device of the measuring configuration.

32: The computer-readable medium according to claim 30, wherein the computer-readable medium is computer-readable data storage device.

33: The computer-readable medium according to claim 30, wherein the executable instructions generate projection images of the first set of projection images for reconstructing the first three-dimensional image as digital images with pixels having binary image values.

34: The computer-readable medium according to claim 33, wherein the executable instructions generate the binary image values by, for each of the pixels, comparing an image value obtained by the detection device with a threshold value.

35: The computer-readable medium according to claim 30, wherein the executable instructions are designed to:
calculate a projection of the three-dimensional image onto a projection plane; and
based on the projection, make at least one determination selected from a group consisting of:
determine whether at least one of a position and an alignment of the test object should be changed relative to at least one of the radiation source and the detection device,
determine whether a method of operating the measuring configuration should be adjusted for subsequently detecting projection images of the test object; and
determine how the method of operating the measuring configuration should be adjusted for subsequently detecting projection images of the test object.

36: A measuring configuration for generating three-dimensional images of test objects using invasive radiation, the measuring configuration comprising:
a radiation source emanating invasive radiation;
a measuring station at which, a test object is penetrated by the invasive radiation emanating from the radiation source;
a detection device for detecting projection images of the test object resulting from absorption of the invasive radiation in the test object;
a reconstruction device reconstructing a first three-dimensional image of the test object from a first set of projection images of the test object, wherein the first set of projection images were detected at various alignments of the test object relative to the radiation source and/or relative to the detection device;
an evaluation device designed to perform an evaluation of the first three-dimensional image; and
a control device designed, depending on a result of the evaluation, performing at least one step selected from the group consisting of:
varying at least one of a position and an alignment of the test object relative to at least one of the radiation source and the detection device, and
adjusting a method of operation of the measuring configuration for subsequently recording projection images of the test object.

37: The measuring configuration according to claim 36, further comprising:
an image generation device connected to the detection device in order to receive detected signals;
the image generation device connected to the reconstruction device in order to output image data based on the detected signals to the reconstruction device; and
the image generation device generating projection images of the first set of projection images for reconstructing the first three-dimensional image as digital images with pixels having binary image values.

38: The measuring configuration according to claim 37, wherein the image generation device generates the binary image values by, for each of the pixels, comparing an image value obtained by the detection device with a threshold value.

39: The measuring configuration according to claim 36, wherein the evaluation device calculates a projection of the first three-dimensional image onto a projection plane such that a two-dimensional projection image is obtained.

40: The measuring configuration according to claim 39, further comprising:
a rotary table used to rotate the test object relative to the radiation source;
wherein the projection plane is perpendicular to a rotational axis of the rotary table.

41: The measuring configuration according to claim 39, wherein:
the evaluation device fits the projection of the three-dimensional image into a contour line of a predetermined shape such that although the projection of the three-dimensional image touches the contour line, the projection of the three-dimensional image does not project beyond the contour line; and
the evaluation device based on the contour line, makes at least one determination selected from a group consisting of:
determining whether at least one of a position and an alignment of the test object should be changed relative to at least one of the radiation source and the detection device,
determining whether a method of operating the measuring configuration should be adjusted for subsequently detecting projection images of the test object; and
determining how the method of operating the measuring configuration should be adjusted for subsequently detecting projection images of the test object.

42: The measuring configuration according to claim 36, wherein the reconstruction device uses back-projection.
